(19) United States
(12) Patent Application Publication
(10) Pub. No.: US 2003/0115155 A1
(43) Pub. Date: Jun. 19, 2003

(54) Issuing certified checks over the internet

(75) Inventor: Wayne M. Doran, Kitchener (CA)

Correspondence Address: MICHAEL CHAN, NCR CORPORATION, 1700 SOUTH PATTERSON BLVD, DAYTON, OH, 45479-0001, US

(73) Assignee: NCR Corporation

(21) Appl. No.: 10/022,957

(22) Filed: Dec. 18, 2001

(51) Int. Cl. G06F 17/60; H04L 9/00

(52) U.S. Cl. 705/75; 705/64

(57) ABSTRACT

A method of certifying checks. A check writer contacts the writer's bank, over the Internet, and requests a certified check. The bank deducts the amount of the check from the writer's account, and issues a validation number to the writer, over the Internet. The writer prints the validation number on the check, in a set of blank spaces designed to accept this number. The check also contains a URL, Uniform Resource Locator, which identifies a web site maintained by the bank. Any interested party, such as a payee of the check, can contact the web site, present the validation number, and learn whether the check is valid. Thus, a certified check can be issued without a visit to a bank, the latter being required under present technology.

### BACKGROUND OF THE INVENTION

Under the Law of Commercial Paper, a class of instruments known as “drafts” exists. Specific terminology is used: a “drawer” orders a “drawee” to pay money to a third person, the “payee.” If the drawee is a bank, and the draft is payable on demand, then the draft is called a “check.”

Sometimes the payee of a check wishes assurance that the check will actually be paid by the drawee-bank. That is, the payee may desire assurances in advance that the check is good, and will not bounce. Several types of check have evolved to provide these assurances.

Three of these checks are officially recognized by the Uniform Commercial Code, and are (1) cashier's checks, (2) teller's checks, and (3) certified checks. These checks provide a high degree of assurance of payment because, in effect, the drawee bank must fail, in order for the payee to be unpaid.

These three checks are different in technical details. A cashier's check is a check which a bank draws on itself: the drawer and drawee are the same.

A teller's check is a check drawn by a bank on another bank.

A certified check is a check drawn by an individual on a bank, but the bank deducts the amount of the check from the individual's account at the time of certifying the check. Thus, funds are allocated for payment of the certified check in advance.

As stated above, for these checks to be returned unpaid, the drawee-bank must fail, which is considered unlikely. Therefore, in many situations, the payee's desire for guaranteed payment is fulfilled by any of these checks. The checks are, from that perspective, equivalent.

However, the drawer of the check may prefer a specific one of these three checks, namely, the certified check. One reason is based on the law of evidence. When the certified check clears the banking system, the certified check may be returned to the drawer, along with the drawer's other paid checks, in the drawer's monthly bank statement.

The drawer is now in possession of the physical check, which has been endorsed by the payee. That physical check is a valuable piece of tangible evidence. The physical check is admissible in court as proof that the payee received the payment indicated by the check. It acts as a signed receipt.

Such evidence does not exist in the case of cashier's checks and teller's checks. With those two checks, even though the payee has endorsed them, and the checks act as a receipt for payment, the drawer is not in possession of the endorsed checks. The banks keep the endorsed checks.

Thus, if the payee asserts that the drawer (who is called the “remitter” in these two cases) did not make payment to the payee, then the remitter must contact the bank, and ask the bank to locate the endorsed check. Further, complications may arise, because the bank may not wish to surrender the physical check to the remitter, but only a copy. However, under the laws of evidence, the copy does not qualify as the “best evidence,” and may not be admitted in court.

Thus, the safest procedure, from the bank's point of view, to get the check admitted as evidence is for an agent of the bank to carry the check to any court hearing, and authenticate the original of the check. Clearly, that is a cumbersome procedure.

Therefore, at least one practical reason commends the use of certified checks over other types. However, obtaining a certified check is inconvenient for the drawer. The drawer must visit a bank in person to obtain the certified check. In addition, banks prefer to avoid issuing certified checks, because some bank procedures require examination of the certified check when it is presented for payment, to assure that the named payee has not changed. For this reason, the bank commonly blanks out the MICR line on the certified check, to assure that it will be flagged and receive personal attention when it arrives in the clearing process.

The invention provides am approach to issuing certified checks over the Internet, which (1) provides the benefits of certified checks but (2) without the inconvenience of requiring the drawer to visit a bank to obtain the certified check.

### OBJECTS OF THE INVENTION

An object of the invention is to provide an improved approach to issuing certified checks.

### SUMMARY OF THE INVENTION

In one form of the invention, a check writer requests a certified check from a bank over the Internet. The bank deducts the amount of the check from the writer's account, and issues a validation number, which the writer prints on the check. An interested party, such as a recipient of the check, can contact a specific web site on the Internet and, using the validation number, verify whether sufficient funds are available to cover the amount of the check.

### BRIEF DESCRIPTION OF THE DRAWINGS

FIGS. 1 and 3 are flow charts illustrating processes implemented by one form of the invention.

FIG. 2 illustrates a check according to one form of the invention.

### DETAILED DESCRIPTION OF THE INVENTION

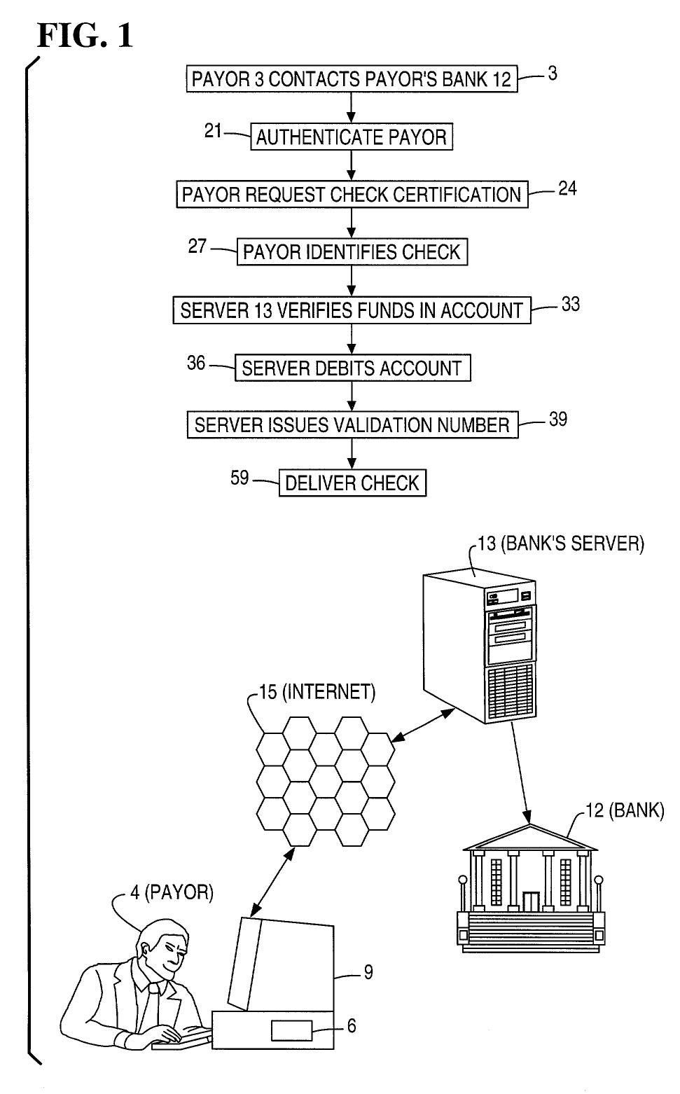

FIG. 1 is a flow chart of processes undertaken by one form of the invention. In block 3, a payor 4 contacts the payor's bank. This contact can be done through software 6 running on the payor's computer 9, which contacts the server 13 of the bank 12 over the Internet 15, using a connection which is rendered secure by appropriate encryption. Alternately, the software 6 can contact the bank 12 directly, over a standard secure telephone connection (not shown).

The payor 4 logs into the server 13 in the usual manner, and is authenticated, as in block 21. The payor indicates that a check is to be certified, as in block 24. The payor identifies the particular check which is to be certified, as by indicating one, or more, of the following: serial number, amount, date, and payee name, as in block 27. “Serial number” refers to the sequence numbers pre-printed on checks.

The payor 4 may, or may not, be required to identify the account number upon which the check is drawn at this time. That is, the server 13 may have previously ascertained the account number when the payor 4 logged in. If not, the payor 4 specifies the account number.

The server 13 in block 33 ascertains that the payor 4 has adequate finds in the account in question to cover the certified check, plus any charges for the certified check. In block 36, server 13 debits the amount of the check and those charges to the account.

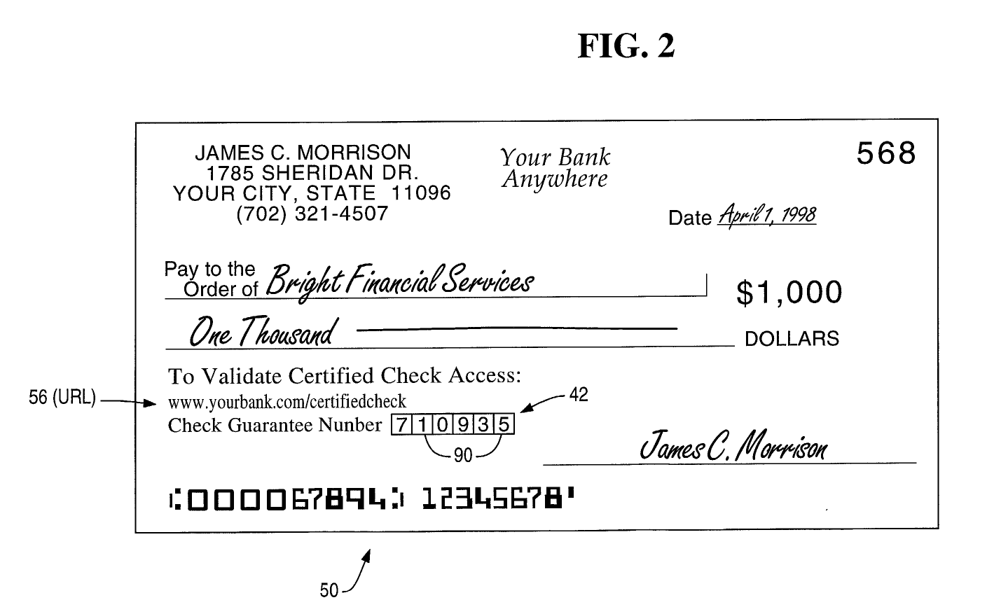

In block 39, the server issues a validation number. The payor 4 writes the validation number onto the check, which is in the payor's possession. The written validation number is illustrated as item 42 in FIG. 2.

FIG. 2 illustrates the check 50. The information on check 50 conforms to that on an ordinary certified check, with two exceptions. One is the presence of the validation number 42, which was issued in block 39 in FIG. 1. The second is the presence of the URL 56, Uniform Resource Locator. The URL identifies a web site on the Internet which can be used to verify the authenticity of the check, as will be explained below.

Therefore, as thus far explained, a customer of a bank logs into a bank's server and requests a certified check. If the customer's account contains sufficient finds to cover the check, the bank (1) deducts the amount of the check and any processing charges from the account and (2) issues a validation number to the customer. The customer fills out the check in the normal manner, and adds the validation number. The check also contains a URL by which a recipient of the check can validate the check.

Block 59 in FIG. 1 indicates that the check 50 is delivered to the payee, which is, according to check 50, “Bright Financial Services.” The check 50 can be delivered by postal mail, courier, personal pick-up, and so on.

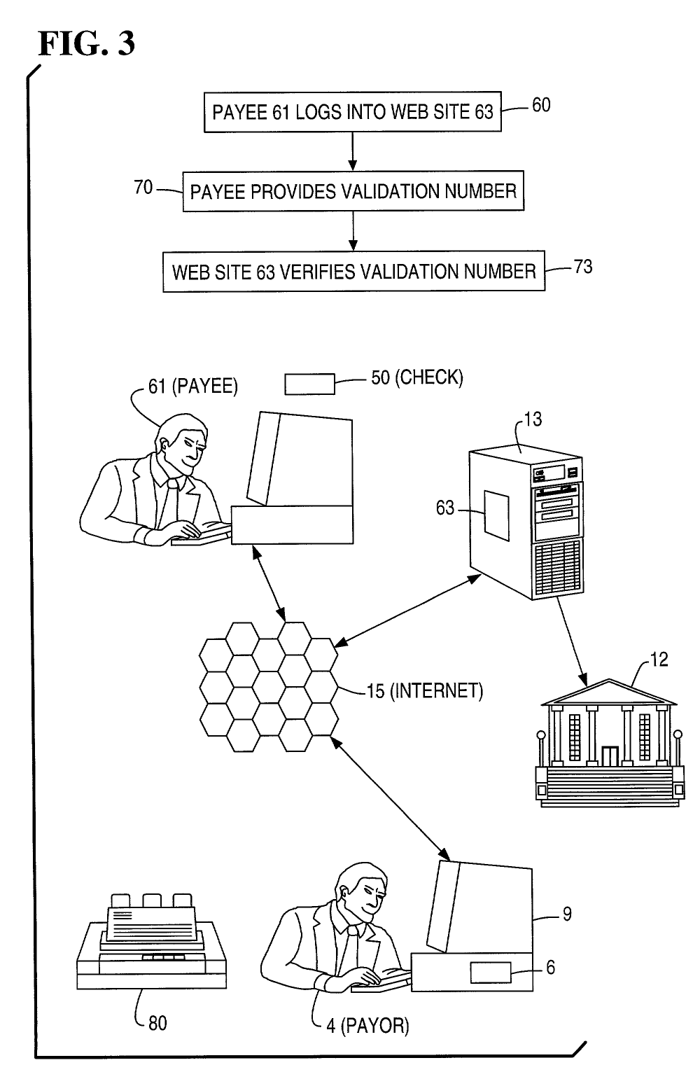

Once the check 50 is delivered to the payee, the invention provides several options to the payee. In FIG. 3, payee 61 is shown as being in possession of the check 50. Block 60 indicates that the payee 61 logs into the web site 63 indicated by the URL 56 in FIG. 2. Payee 61 performs this log-in using the Internet. This web site 63 can be maintained by the drawee bank 12.

The payee provides the validation number 42 to the web site 63, as indicated by block 70 in FIG. 3, plus perhaps additional information, such as selected contents from the check 50. Significantly, in one form of the invention, the payee provides information to the web site 63, as opposed to the web site 63 providing the contents of the check 50 to the payee. That is, the web site 63 only confirms the contents, if correctly presented. This procedure creates difficulties for parties who may wish to steal validation numbers. For example, a person would not ask the web site 63, “What is the dollar amount of the check ?” Rather, the person would state a dollar amount, and the web site 63 would confirm or deny that amount. Also, the web site 63 would only allow a limited number of attempts by any person.

As indicated in block 73 in FIG. 3, the web site 63 verifies that the validation number 53 is valid. The web site 63 may also provide other data which identifies the check, such as (1) serial number, (2) date, (3) payee, and so on, in order to assure the payee 61 that the web site 63 is responding to the proper check.

At some point, the certified check will enter the check-clearing system, and be returned to the drawee-bank. A specific feature of one form of the invention is that the certified check is not flagged, nor ejected for hand processing at this time. It is processed like any other common check when received by the drawee bank. For example, if a small business receives 20 checks in one month, plus a certified check issued in accordance with one form of the invention, all 21 checks would be processed in the same way by the check-clearing system.

Additional Considerations

1. The preceding discussion presumed that the payor printed the validation number 42 on the check 50 in FIG. 2, printing each number in one of a set of pre-printed boxes 90. In another form of the invention, a printer 80 associated with the payor 4 in FIG. 1 causes the check to be printed. Preferably, the printer 80 is a fusible toner, or “laser,” type of printer, as opposed to an ink-jet printer. Many ink-jet printers use water-soluble ink, which can lend themselves to alteration.

Further, the printer 80 need not be located at the home or office of the payor 4. For example, the payor 4 may visit an automobile dealership (not shown), and undertake the processes indicated in FIG. 1, but using the dealership's computers. The check 50 would be printed at a printer at the dealership. As another example, the printer 80 may be located at a self-service kiosk, or at an Automated Teller Machine, ATM.

2. The terms “certified” and “check” are terms-of-art, and are used with the definitions assigned to them in the Uniform Commercial Code.

For example, it could be argued that, when one presents an ordinary check to a bank for cashing, that check becomes “certified.” The basis of the argument is that various laws state that, when a person presents a check for payment, that person makes certain warranties, such as (1) the person is the named payee, (2) the person has legal possession of the check, and so on. Thus, the argument would continue, the person “certifies” various things about the check, so that the check has been “certified.”

However, that type of certification is not the type which the UCC refers to in “certified” checks. One definition of certified check is a check for which the drawee bank has deducted the amount of the check from the drawer's account at the time of issuance of the check.

Another definition would be that a certified check is a check for which the drawee bank has been paid in advance. This definition may apply in a case where the amount of the check was not actually deducted from an account of the payor, but the payor made a deposit in the account using an advance on a credit card.

3. The validation number 42 in FIG. 2 provides a specific function, which can be described in perhaps several different ways. One description is that the validation number 42 allows a party to verify that a paper check having a given date, serial number, amount, and payee, was certified by a given bank. (In this situation, of course, the bank and the payor agree upon the date, serial number, amount, and payee at the time of the certification. The bank, for example, does not provide the validation number on Monday, but then the payor writes the check using a date of the payor's choice.) Thus, in a sense, the validation number identifies the check, or the transaction.

The validation number 42 acts as a link, or address, for storage of a data block of information relevant to the check. Further, that data block, which can contain a single item, such as YES or NO, or can contain data indicating the contents of the certified check, can be made available over the Internet. and can be made available without human intervention. For example, web site 63 in FIG. 3 can maintain the data blocks. When a person logs in and presents a validation number 42, the web site 63 confirms or denies that the validation number is valid. If the person wishes more information, then the web site confirms or denies each element of the check presented, such as date, amount, and so on.

Therefore, in one form of the invention, a system and procedure is provided wherein a check can be identified to a computer process over the Internet, and the process will confirm or deny that the check is properly certified, again over the Internet.

4. Preferably, for purposes of minimizing the possibility of fraud, the validation number 42 is randomly generated by the bank alone. However, the validation number 42 need not be chosen by the bank 12 alone. The validation number 42 can, in effect, be agreed upon, tacitly or explicitly, by the payor 4 and the bank 12. For example, the bank 12 may collect information from the payor 4, such as (1) date of the check, (2) amount, (3) check serial number, (4) account number, and so on. The bank 12 may select a subset of those items which uniquely identify the certified check. The bank 12 may use that subset as the validation number. Alternately, the bank 12 may generate its own validation number. As another alternate, the bank may combine a subset with its own generated number.

But, in any case, the validation number is an item of data which identifies the check in question, or the transaction in question, so that the bank 12 can later confirm that the certified check was, in fact, validly issued in that transaction. The bank makes available, at a web site, a list of validation numbers, and, for each validation number, one or more items of data, which confirm, or deny, that a certified check was issued for each number.

5. In one form of the invention, the payor 4 in FIG. 1 is remote from the drawee bank 12. Also, the printer 80 which prints the check can be remote from the drawee bank.

One definition of “remote” is that the agent in question (payor or printer) is outside the building which houses the drawee bank 12. Another definition is that the agent in question is at least ½ mile from the drawee bank 12.

6. The invention discussed above presumed that the payor 4 will complete and sign check 50 in FIG. 2. However, the payor 4 can delegate an agent to perform these tasks, and this would occur if the payor 4 is a corporation. Further, many different people may have rights to issue checks on a given account, such as in a business, or in a family.

Therefore, in the more general case, the authentication of block 21 in FIG. 1 actually inquires whether the requested transaction is authorized under applicable law. That inquiry may include (1) verifying identity of the requesting party and (2) verifying that the party identified has authority to issue the check.

7. The validation number 42 should not be confused with ordinary serial numbers printed on checks. In one form of the invention, a party requests a certified check, and the bank issues a validation number for the check. However, the check used by the party will probably also contain a serial number, the so-called “check number.”

In another approach, a bank issues a certified check in the usual manner. That check probably contains a serial number. However, that serial number was not issued at the time of certification. It was issued when the check was printed, which was, in general, long previous to the request for certification. Nor does that check contain both a validation number 42 and a serial number.

From another perspective, the validation number 42 of the invention did not exist on this certified check prior to the request for certification.

8. The term “number” in “validation number” is taken in the generic sense. That is, the “number” may be a quantity, such as 717171. More generally, the “number” can be a character sequence. However, since various coding schemes exist for encoding characters, such as “A”, into numbers, a character sequence can still be viewed as a number.

From another point of view, the validation number, in practice, will take the form of a string of bits, that is, a string of ONEs and ZEROEs. That can be viewed as a number.

9. FIGS. 1 and 3 illustrate systems comprising software, hardware, and other apparatus which implement at least one form of the invention.

10. FIG. 2 shows six boxes 90, each for containing one digit of the validation number. The number six is exemplary only, and the actual number used will depend on (1) the level of security desired and (2) convenience to the payor 4 in transcribing the digits into the boxes 90.

Numerous substitutions and modifications can be undertaken without departing from the true spirit and scope of the invention. What is desired to be secured by Letters Patent is the invention as defined in the following claims.

What is claimed is:

1. A method of operating a financial institution, comprising:
a) obtaining, over a communication link, a request for a certified check;
b) verifying that issuance of the check is authorized under law; and
c) issuing a validation number for the check.

2. Method according to claim 1, wherein the request identifies a specific bank account.

3. Method according to claim 1, wherein the communication link comprises the Internet.

4. Method according to claim 1, wherein the process of verifying comprises verifying that the request was made by a party authorized to write checks on the specific account.

5. Method according to claim 4, wherein the process of verifying further comprises verifying that the specific account contains funds sufficient to cover the check.

6. Method according to claim 1, wherein the validation number did not exist on the check prior to the request.

7. Method according to claim 1, wherein the certified check contains the following information:
i) date;
ii) account number of the specific account;
iii) symbols identifying a drawee bank which maintains custody of the specific account; and
iv) a Uniform Resource Locator, URL.

8. Method according to claim 1, and further comprising
d) deriving a validation number for the certified check.

9. Method according to claim 8, and further comprising:
e) applying symbols to the certified check which indicate the validation number.

10. A method, comprising:
a) receiving from a party over the Internet (i) a request for a certified check and (ii) a monetary amount of the check;
b) authenticating identity of the party; and
c) ascertaining whether an account of the party contains funds sufficient to cover the certified check and, if so, issuing over the Internet a validation number to the party.

11. Method according to claim 10, and further comprising:
d) after issuing the validation number,
i) receiving one or more inquiries which present numbers, and
ii) if a number conforms to the validation number, issuing a confirmation.

12. Method according to claim 11, in which the inquiries are received in an Internet communication.

13. Method according to claim 11, in which the confirmation is issued in an Internet communication.

14. System, comprising:
a) means for receiving, from a requestor, a request over the Internet for issuance of a certified check;
b) means for establishing a reference character sequence for the check;
c) means for transmitting the reference character sequence to the requestor over the Internet; and
d) means receiving a proposed character sequence over the Internet and, if the proposed character sequence matches the reference character sequence, issuing a confirmation signal.

15. System according to claim 14, wherein a web site receives the proposed character sequence.

16. System according to claim 15, wherein the web site issued the confirmation signal.
